(19) United States
(12) Patent Application Publication
(10) Pub. No.: US 2026/0158526 A1
(43) Pub. Date: Jun. 11, 2026

(54) PINBALL MACHINE CLEANING DEVICE

(71) Applicant: Anthony Pepe, Poughkeepsie, NY (US)

(72) Inventor: Anthony Pepe, Poughkeepsie, NY (US)

(21) Appl. No.: 18/969,530

(22) Filed: Dec. 5, 2024

(51) Int. Cl. B08B 9/043; A63F 7/02

(52) U.S. Cl. CPC B08B 9/0436; A63F 7/025; B08B 2209/04

(57) ABSTRACT

A pinball machine cleaning device is provided for cleaning a pinball machine including hidden ball pathways without having to disassemble the pinball machine fully. The device includes an elongated body being laterally flexible along a length of the body. A cloth is positionable around the body such that the cloth contact a playing surface of a pinball machine when the body is moved on the playing surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cleaning device and more particularly pertains to a new cleaning device for cleaning a pinball machine including hidden ball pathways without having to disassemble the pinball machine fully.

### (2) Description of Related Art Including Information Disclosed Under 37 CFR 1.97 and 1.98.

The prior art relates to cleaning devices. Known cleaning devices such as brushes lack shape and design to facilitate pushing the device into and through hidden ball pathways of a pinball machine.

### BRIEF SUMMARY OF THE INVENTION

An embodiment of the disclosure meets the needs presented above by generally comprising an elongated body being laterally flexible along a length of the body. A cloth is positionable around the body such that the cloth contact a playing surface of a pinball machine when the body is moved on the playing surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a pinball machine cleaning device according to an embodiment of the disclosure.

FIG. 2 is a top view of an embodiment of the disclosure.

FIG. 3 is a side view of an embodiment of the disclosure.

FIG. 4 is a top view of an embodiment of the disclosure.

FIG. 5 is a front end view of an embodiment of the disclosure.

FIG. 6 is a front end view of an embodiment of the disclosure.

FIG. 7 is a top front side perspective view of an embodiment of the disclosure.

FIG. 8 is a top view of an embodiment of the disclosure in use.

FIG. 9 is a top view of an embodiment of the disclosure in use.

FIG. 10 is a top view of an embodiment of the disclosure in use.

### DETAILED DESCRIPTION OF THE INVENTION

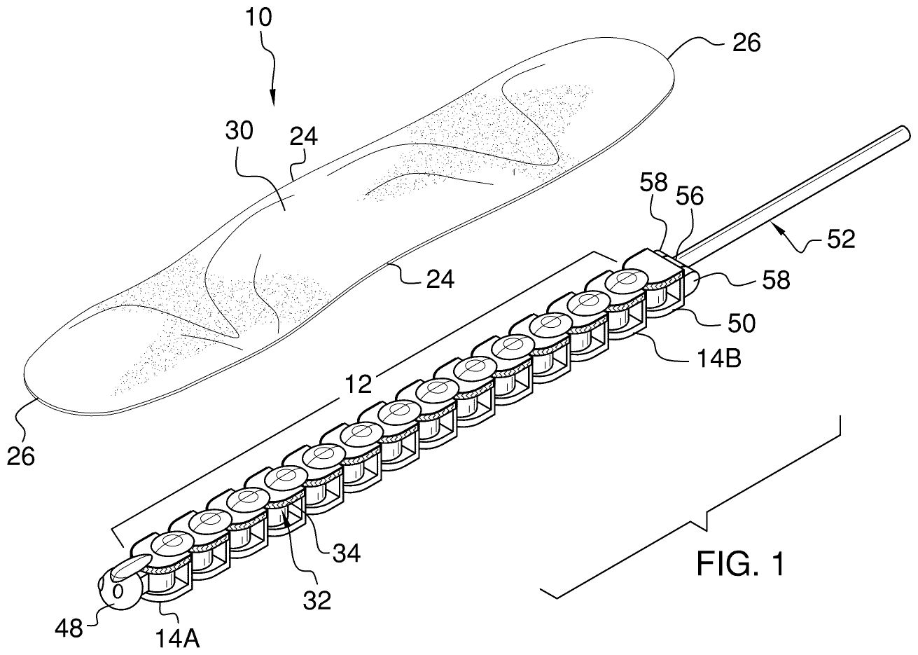

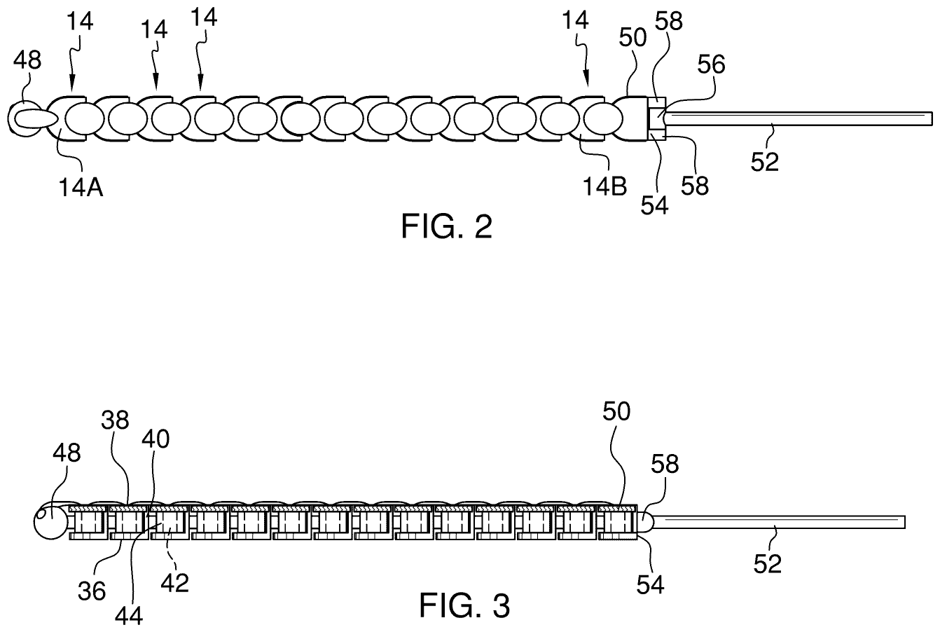

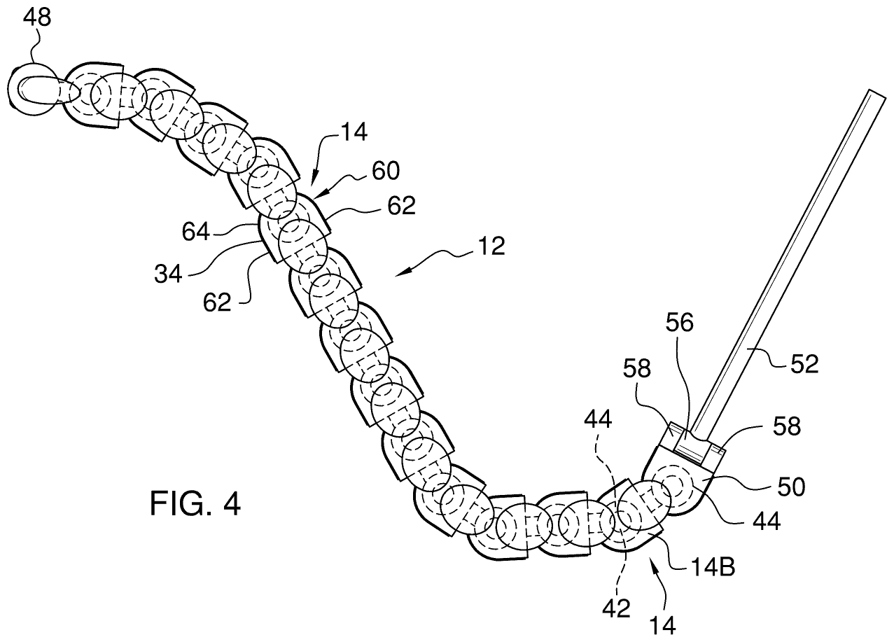

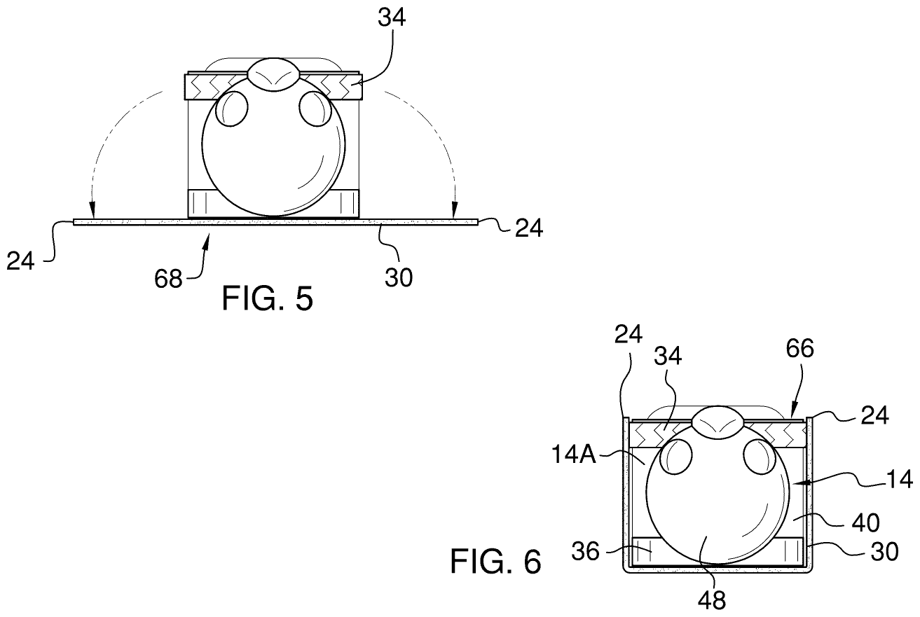

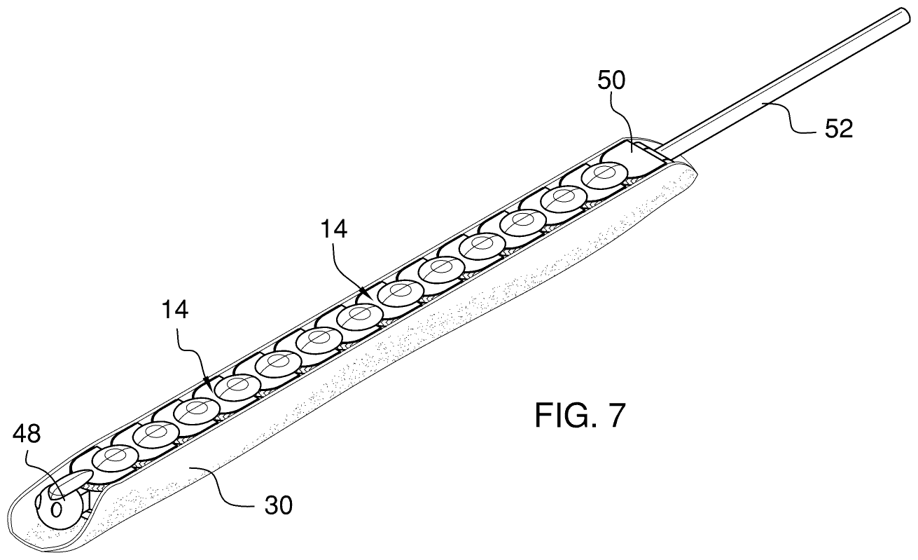

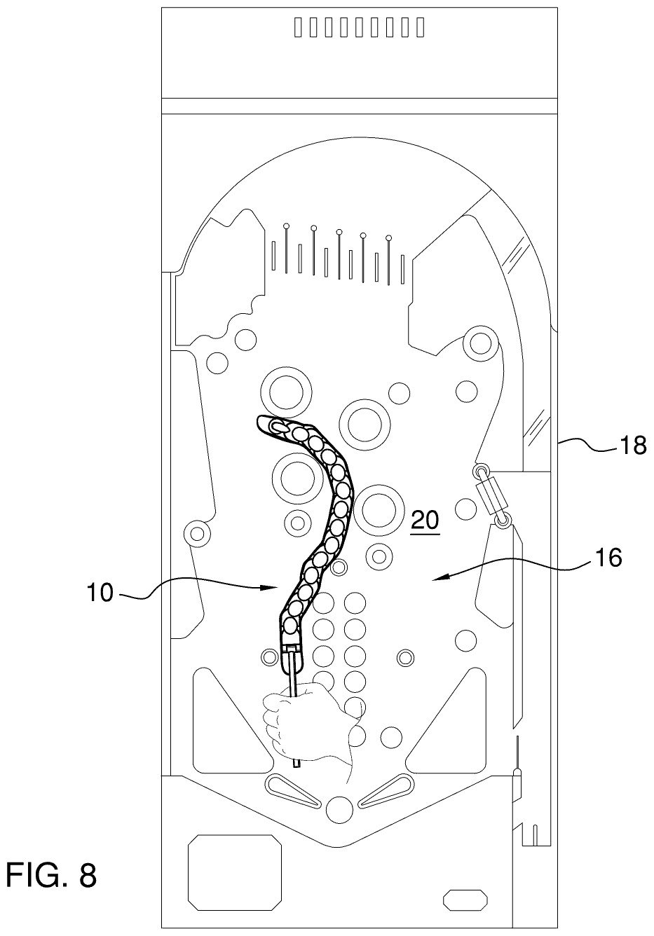

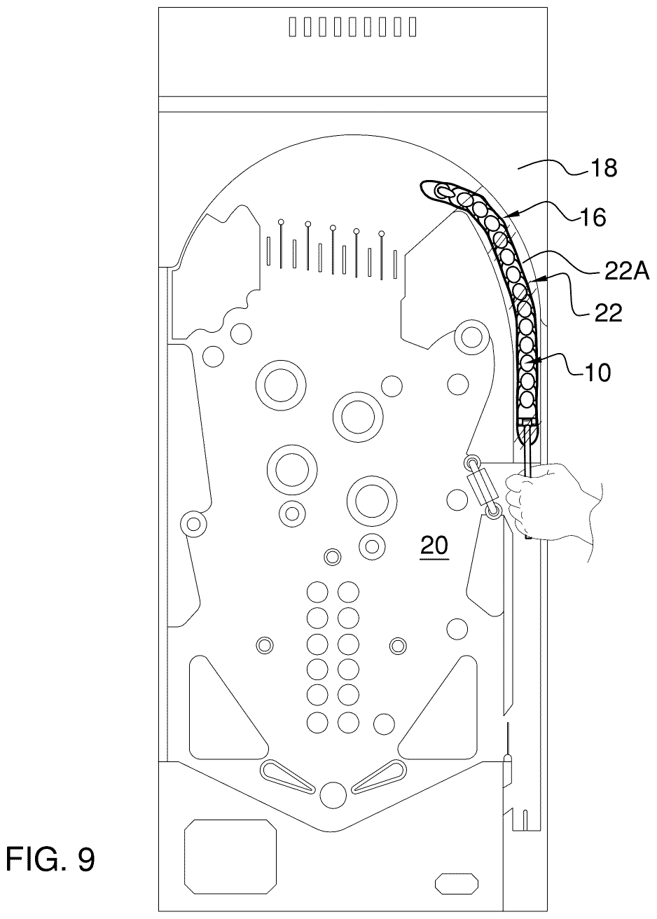

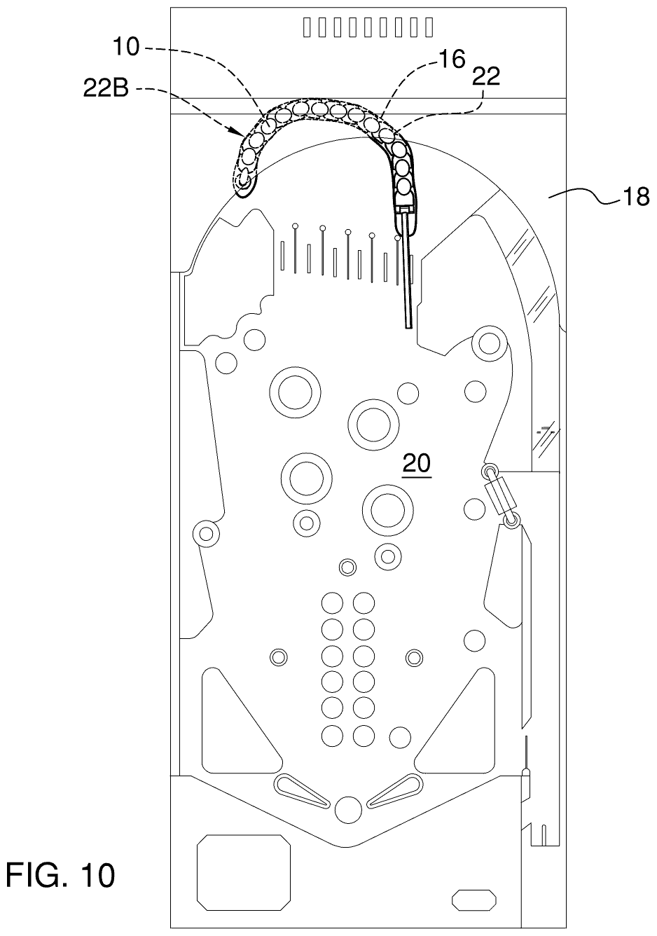

With reference now to the drawings, and in particular to FIGS. 1 through 10 thereof, a new cleaning device embodying the principles and concepts of an embodiment of the disclosure and generally designated by the reference numeral 10 will be described.

As best illustrated in FIGS. 1 through 10, the pinball machine cleaning device 10 generally comprises a body 12 which is elongated and laterally flexible along a length of the body 12. The body 12 includes a plurality of segments 14. Each segment of the plurality of segments 14 is pivotally connected to an adjacently positioned segment 14 of the plurality of segments 14. Thus, the body 12 can pivot laterally along the length at a junction of the segments 14 for conform a shape of the body 12 into curves towards a single side or into an S-shape along the length of the body 12. A cloth 30 is positionable around the body 12 to contact a playing surface 16 of a pinball machine 18 when the body 12 is moved on the playing surface 16. The playing surface 16 includes the main playfield 20 and pathways 22 including ramps, channels, and the like found in conventional pinball machines. The playing surface 16 within the pathways 22 includes bottom and sidewall surfaces which may be contacted by a pinball during use of the pinball machine 18. The pathways 22 may include both exposed pathways 22A and hidden pathways 22B. It is contemplated that the exposed pathways 22A are those which are exposed and generally fully accessible or visible when the glass of the pinball machine 18 is removed. It is further contemplated that the hidden pathways 22B are those which are covered, partially covered, or extend and tunnel into a rear section of the pinball machine 18. It is noted that the size of pinballs used in conventional pinball machines is standardized such that the general dimensions of the pathways 22 are substantially standardized to promote movement of the pinball in a consistent path through the pathways 22. Thus, the body 12 is dimensioned such that the cloth 30, when attached, is positioned to contact and clean bottom and lateral surfaces of the pathway 22 when the body 12 and cloth 30 are moved through the pathway 22. The height of the body 12 is such that the body 12 will pass through covered areas, i.e. it will have a height to allow sufficient clearance, which may be less than the diameter of a conventional pinball. The height may be greater than a radius of a standard or conbentional pinball to provide for cleaning of surfaces adjacent to, meaning above and below, a line of contact of a pinball on the playing surface 16. The cloth 30 is elongated having elongated side edges 24 and curved ends 26 extending between the elongated side edges 24 wherein the cloth 30 is obround shaped. While the specific definition of obround provides that the ends are semi-circular in shape, it is contemplated here that obround may include also parabolic curvature at the ends of the cloth 30.

A fastener 32 is coupled to the body 12. The fastener 32 engages the cloth 30 when the cloth 30 is positioned around the body 12. Thus, the fastener 32 secures the cloth 30 to the body 12. The fastener 32 engages the cloth 30 when the cloth 30 is positioned around the body 12 such that the fastener 32 secures the cloth 30 to the body 12. The fastener 32 includes a plurality of hook fastener sections 34 which are generally conventional nylon hook structure of hook and loop fastener. Each hook fastener section 34 is coupled to an associated segment 14 of the plurality of segments 14 of the body 12. Each segment 14 of the body 12 includes a base wall 36, a top wall 38, and a rear wall 40 extending between the base wall 36 and the top wall 38. The base wall 36 and the top wall 38 each extend forwardly from the rear wall 40. A column 42 extends between the base wall 36 and the top wall 38 of each segment 14. The column 42 is spaced from the rear wall 40. Each segment 14 further includes an arm 44 extends rearwardly from the rear wall 40. The arm 44 engages the column 42 of the adjacently positioned segment 14 of the plurality of segments 14 such that the arm 44 is free to pivot relative to the column 42 of the adjacently positioned segment 14 of the plurality of segments 14.

A head segment 48 may be coupled to a forwardmost segment 14A of the plurality of segments 14 of the body 12. The head segment 48 is constructed to resemble a head of an animal, typically that of a snake which has physical characteristics which correspond generally to the elongated and flexible nature of the body 12. The head segment 48 is pivotally coupled to the forwardmost segment 14A of the plurality of segments 14 of the body 12. An end segment 50 pivotally coupled to a terminal segment 14B of the plurality of segments 14 of the body 12. The end segment 50 generally has the same structure as each segment 14 of the body 12 absent the arm 44. A handle 52 may be coupled to and extend rearwardly from a back surface 54 of the end segment 50. The handle 52 may be T-shaped having a cross section 56 with ends positioned in bearings 58 extending from the back surface 54 of the end segment 50 such that the handle 52 is pivotable relative to the end segment 50. The handle 52 pivots in a plane perpendicular to a plane in which the plurality of segments 14 pivot.

Each hook fastener section 34 of the plurality of hook fastener sections 34 is coupled to a peripheral edge 60 of the top wall 38 of the associated segment 14 of the plurality of segments 14 of the body 12. The peripheral edge 60 of the top wall 38 of the associated segment 14 of the plurality of segments 14 of the body 12 has a pair of straight sections 62 and an arcuate section 64 extending between the straight sections 62. The straight sections 62 are parallel to each other. Each hook fastener section 34 is positioned on the straight sections 62 of the peripheral edge 60 of the top wall 38 of the associated segment 14 of the plurality of segments 14 of the body 12. As the body 12 pivots along the length outer portions of the arcuate section 64 may contact parts of the playing surface 16 of the pinball machine 18. Thus, the hook fastener sections 34 may be positioned to extend partially or fully along the straight sections 62 and the arcuate section 64 of the peripheral edge 60 of the top wall 38. The size of the cloth 30 generally corresponds to the size of the body 12, head segment 48, and end segment 50. The cloth 30 further has a width such that elongated side edges 24 of the cloth 30 are positioned adjacent to a top edge 66 of the top wall 38 when the cloth 30 is positioned to extend around a bottom 68 of the body 12. When engaged to the body 12, the cloth 30 will not have bunched areas to promote consistent and full contact of the cloth 30 with the playing surfaces 16 of the pinball machine 18.

In use, the cloth 30 is engaged to the body 12 and the body 12 is then manipulated to contact the playing surfaces 16 of the pinball machine 18. The cloth 30 may be used for simple dusting or an appropriate cleanser or protective substance may be used with the cloth 30. The cloth 30 is replaceable such that it may be cleaned or replaced as needed with another cloth 30. The body 12 may be positioned within exposed pathways 22A or at the entrance to hidden pathways 22B and pushed through to clean the playing surface 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pinball machine cleaning device comprising:
a body, said body being elongated, said body being laterally flexible along a length of said body;
a cloth, said cloth being positionable around said body wherein said cloth is configured to contact a playing surface of a pinball machine when said body is moved on the playing surface.

2. The pinball machine cleaning device of claim 1, further comprising said body including a plurality of segments, each segment of said plurality of segments being pivotally connected to an adjacently positioned segment of said plurality of segments.

3. The pinball machine cleaning device of claim 1, further comprising a fastener coupled to said body, said fastener engaging said cloth when said cloth is positioned around said body wherein said fastener secures said cloth to said body.

4. The pinball machine cleaning device of claim 2, further comprising a fastener coupled to said body, said fastener engaging said cloth when said cloth is positioned around said body wherein said fastener secures said cloth to said body, said fastener including a plurality of hook fastener sections, each hook fastener section being coupled to an associated segment of said plurality of segments of said body.

5. The pinball machine cleaning device of claim 4, wherein each segment of said body comprises:
a base wall, a top wall, and a rear wall extending between said base wall and said top wall, said base wall and said top wall each extending forwardly from said rear wall;
a column extending between said base wall and said top wall, said column being spaced from said rear wall,
an arm, said arm extending rearwardly from said rear wall, said arm engaging said column of said adjacently positioned segment of said plurality of segments such that said arm is free to pivot relative to said column of said adjacently positioned segment of said plurality of segments.

6. The pinball machine cleaning device of claim 2, further comprising a head segment coupled to a forwardmost segment of said plurality of segments of said body, said head segment being constructed to resemble a head of an animal.

7. The pinball machine cleaning device of claim 6, further comprising said head segment being pivotally coupled to said forwardmost segment of said plurality of segments of said body.

8. The pinball machine cleaning device of claim 2, further comprising an end segment pivotally coupled to a terminal segment of said plurality of segments of said body.

9. The pinball machine cleaning device of claim 8, further comprising a handle coupled to and extending rearwardly from a back surface of said end segment.

10. The pinball machine cleaning device of claim 9, further comprising said handle being pivotable relative to said end segment.

11. The pinball machine cleaning device of claim 10, further comprising said handle pivoting in a plane perpendicular to a plane in which said plurality of segments pivot.

12. The pinball machine cleaning device of claim 5, further comprising each hook fastener section of said plurality of hook fastener sections being coupled to a peripheral edge of said top wall of said associated segment of said plurality of segments of said body.

13. The pinball machine cleaning device of claim 12, further comprising said peripheral edge of said top wall of said associated segment of said plurality of segments of said body having a pair of straight sections and an arcuate section extending between said straight sections.

14. The pinball machine cleaning device of claim 13, further comprising said straight sections being parallel to each other.

15. The pinball machine cleaning device of claim 12, further comprising each hook fastener section being positioned on said straight sections of said peripheral edge of said top wall of said associated segment of said plurality of segments of said body.

16. The pinball machine cleaning device of claim 12, further comprising each hook fastener section extending fully along said straight sections and said arcuate section of said peripheral edge of said top wall.

17. The pinball machine cleaning device of claim 12, further comprising said cloth being elongated having elongated side edges.

18. The pinball machine cleaning device of claim 17, further comprising said elongated side edges being positioned adjacent to a top edge of said top wall when said cloth is positioned to extend around a bottom of said body.

19. The pinball cleaning machine device of claim 18, further comprising said cloth having curved ends extending between said elongated side edges wherein said cloth is obround shaped.

20. A pinball machine cleaning device comprising:
a body, said body being elongated, said body being laterally flexible along a length of said body, said body including a plurality of segments, each segment of said plurality of segments being pivotally connected to an adjacently positioned segment of said plurality of segments;
a cloth, said cloth being positionable around said body wherein said cloth is configured to contact a playing surface of a pinball machine when said body is moved on the playing surface, said cloth being elongated having elongated side edges, said cloth having curved ends extending between said elongated side edges wherein said cloth is obround shaped;
a fastener coupled to said body, said fastener engaging said cloth when said cloth is positioned around said body wherein said fastener secures said cloth to said body, said fastener engaging said cloth when said cloth is positioned around said body wherein said fastener secures said cloth to said body, said fastener including a plurality of hook fastener sections, each hook fastener section being coupled to an associated segment of said plurality of segments of said body;
wherein each segment of said body includes
a base wall, a top wall, and a rear wall extending between said base wall and said top wall, said base wall and said top wall each extending forwardly from said rear wall,
a column extending between said base wall and said top wall, said column being spaced from said rear wall, and
an arm, said arm extending rearwardly from said rear wall, said arm engaging said column of said adjacently positioned segment of said plurality of segments such that said arm is free to pivot relative to said column of said adjacently positioned segment of said plurality of segments;
a head segment coupled to a forwardmost segment of said plurality of segments of said body, said head segment being constructed to resemble a head of an animal, said head segment being pivotally coupled to said forwardmost segment of said plurality of segments of said body.
an end segment pivotally coupled to a terminal segment of said plurality of segments of said body;
a handle coupled to and extending rearwardly from a back surface of said end segment, said handle being pivotable relative to said end segment, said handle pivoting in a plane perpendicular to a plane in which said plurality of segments pivot.
wherein each hook fastener section of said plurality of hook fastener sections is coupled to a peripheral edge of said top wall of said associated segment of said plurality of segments of said body, said peripheral edge of said top wall of said associated segment of said plurality of segments of said body having a pair of straight sections and an arcuate section extending between said straight sections, said straight sections being parallel to each other, each hook fastener section being positioned on said straight sections of said peripheral edge of said top wall of said associated segment of said plurality of segments of said body, each hook fastener section extending fully along said straight sections and said arcuate section of said peripheral edge of said top wall; and
wherein said elongated side edges of said cloth are positioned adjacent to a top edge of said top wall when said cloth is positioned to extend around a bottom of said body.
